(19) United States
(12) Patent Application Publication
(10) Pub. No.: US 2026/0218982 A1
(43) Pub. Date: Jul. 30, 2026

(54) APPARATUS FOR DRYING A PRINTED MATERIAL WEB

(71) Applicant: BHS Corrugated Maschinen- und Anlagenbau GmbH, Weiherhammer (DE)

(72) Inventors: Christoph Dütsch, Parkstein (DE); Christopher Prechtl, Falkenberg (DE); Thomas Schemmel, Bechtsrieth (DE)

(21) Appl. No.: 19/145,129

(22) PCT Filed: Jan. 10, 2024
(86) PCT No.: PCT/EP2024/050448

§ 371 Date: Jul. 1, 2025

(30) Foreign Application Priority Data
Jan. 12, 2023 (DE) 10 2023 200 207.8

(51) Int. Cl. F26B 13/10; F26B 3/28

(52) U.S. Cl. CPC F26B 13/10; F26B 3/283

(57) ABSTRACT

The invention relates to an apparatus (8) for drying a printed material web (6). The apparatus comprises at least two drying units (22), wherein each drying unit (22) has a radiator device (26) which is arranged under a conveying region (16) and has a number of infrared radiators (36) and has a radiator ventilator (38) for supplying air (A) to the infrared radiator (36) and into the conveying region (16); a radiator suction apparatus (28) which is arranged downstream of the radiator device (26) in the drying unit longitudinal direction (L) for the air (A) supplied by the radiator ventilator (38) into the conveying region (16); and a first air knife (30) which is arranged upstream of the radiator device (26) in the drying unit longitudinal direction (L) for generating an air jet (K) for detaching a laminar boundary layer on the material web (6). Between the drying units (22), an intermediate suction apparatus (42) is arranged in each case to suction off evaporated solvent.

The invention relates to an apparatus for drying a printed material web having infrared radiators. The material web is in particular a paper, cardboard or carton web or a film web.

When printing a material web, a printing ink is applied to the material web using a printing device. If a solvent-based and/or water-based printing ink is used, the material web is expediently exposed to infrared radiation after printing. Using infrared radiation, the printed material web is by evaporating water and/or solvent.

For example, DE 10 2005 046 230 A 1 discloses a rotary printing press comprising several printing units. The last printing unit in the direction of the conveyance path of the printed sheet is followed by a drying system having at least one IR ink dryer.

Furthermore, an infrared heating unit for drying ink is known from DE 10 2018 122 910A1 .

The invention is based on the object of providing a particularly suitable apparatus for drying a printed material web. In particular, the apparatus should enable the most efficient drying possible.

With regard to the apparatus, this object is achieved according to the invention by the features of claim 1. Advantageous developments and embodiments are the subject of the dependent claims.

The apparatus is provided and configured for drying a printed material web, in particular for drying the printing ink applied to the material web.

Preferably, the material web is a paper web, a cardboard web, a carton web, or a film web.

The apparatus comprises at least two, i.e., two or more than two, for example three, four, five or six, drying units. They are conveniently configured to be arranged one behind the other along the material web. The drying units are arranged in series with regard to the material web. This means that, when the apparatus is in operation, the material web is treated successively by the drying units.

Each of the drying units comprises a radiator device which is arranged under a conveying region for the material web, i.e., under a region through which the material web is conveyed during operation of the apparatus. The radiator device comprises a number of infrared radiators, i.e., a single infrared radiator or more than one infrared radiator, for example 10, 20, 30, 40, 50 or 60 radiators. They are provided and configured to irradiate the material web, in particular its printed side, with infrared radiation in order to evaporate water and/or solvent.

The infrared radiators of the respective radiator device are expediently arranged next to one another in a direction transverse to the material web or transverse to the respective drying unit longitudinal direction. Preferably, the infrared radiators can be controlled, in particular switched on or off, individually or the two outer ones can be controlled, in particular switched on or off. In this way, only those infrared radiators that are arranged directly above the material web can be operated. In other words, it is made possible to adapt the number and/or arrangement of the infrared radiators for the drying process to the respective width of different material webs, so that only the infrared radiators irradiating the material web are operated.

Furthermore, the radiator performance and/or the temperature of the infrared radiators of one of the drying units can preferably be adjusted independently of the radiator performance and/or the temperature of the infrared radiators of the other drying unit(s).

A radiator ventilator of the radiator device is configured to supply air to the infrared radiators in order to control their temperature and to convey the air into the conveying region. Therefore, using the radiator ventilator, (tempered) air is conveyed to the number of infrared radiators and the air heated during cooling is conveyed from the infrared radiators into the conveying region-and to the material web when the apparatus is in operation. The air conveyed into the conveying region thus transports away evaporated solvent or water vapor in the region of the radiator device, so that infrared radiation is not reflected by this solvent. In addition, the material web is dried convectively with said supplied air. Expediently, the housing of the radiator device serves as a guide for the air supplied by the radiator ventilator.

Furthermore, each of the drying units comprises a radiator suction apparatus for the air supplied by the radiator ventilator into the conveying region. The radiator suction apparatus is arranged behind the radiator device in a direction referred to as the drying unit longitudinal direction of the respective drying unit.

Expediently, the infrared radiation emitted by the radiator device of one of the drying units, in particular its intensity and/or spectral composition, can be adjusted independently of the infrared radiation that is or will be emitted by the radiator device of one of the other drying units. In this way, for each of the drying units, the infrared radiation particularly suitable for drying the material web can be adapted to the respective drying state of the material web.

Each of the drying units further comprises a first air knife arranged upstream of its radiator device in the drying unit longitudinal direction of the respective drying unit. An air knife is understood to mean herein and hereinafter a device with the nozzle of which a comparatively flat, plane-like air jet can be emitted. The first air knife is used to generate an air jet, by means of which a laminar boundary layer pulled along by the material web is detached, i.e., separated and removed, therefrom. In this way, it is avoided, or at least the risk is reduced, that the infrared radiation generated by the infrared radiators is reflected due to such a boundary layer and thus that the drying performance is reduced. This advantageously results in comparatively efficient drying of the printed material web or printing ink applied to the material web.

Expediently, the air flow, in particular its volume flow and/or its flow velocity, of the first air knife of one of the drying units can be adjusted independently of the air flow of the first air knife of one of the other drying units. In this way, for each of the drying units, the air flow emitted by the respective first air knife can be adapted to the drying state of the material web. For example, the air flow velocity is set comparatively low in the drying units upstream of the conveying direction of the material web in order to prevent the printing ink from running.

In summary, with regard to the drying unit longitudinal direction, the radiator device is arranged between the first air knife and the radiator suction apparatus.

The apparatus further comprises an intermediate suction apparatus which is arranged between two of the drying units, in particular along the material web and/or with respect to the drying unit longitudinal directions. The intermediate suction apparatus can suction off supply air and/or solvent evaporated from the material web, thus preventing an accumulation of solvent in the air and/or uncontrolled evaporation of the solvent from the printing ink in the region of the radiator devices.

The material web is expediently conveyed in or substantially in the drying unit longitudinal direction through or along the respective drying unit.

In summary, the use of at least two drying units (dryer units) makes it possible to remove solvent or water from the material web at several points along the material web. Consequently, the drying efficiency is advantageously increased.

According to an advantageous embodiment, the first air knife is configured such that the air jet generated by the air knife is inclined against the drying unit longitudinal direction of the respective drying unit. In other words, the plane spanned by the air jet is inclined against the drying unit longitudinal direction. Thus, the air jet has at least one flow velocity component that is oriented counter, i.e., antiparallel, to the conveying direction (web running direction) of the material web, or counter to the drying unit longitudinal direction. Therefore, a relative velocity of the air jet and of the material web conveyed in or substantially in the drying unit longitudinal direction is increased. Advantageously, detachment of the laminar boundary layer is made easier.

According to an advantageous development, each of the drying units has an air knife suction apparatus for suctioning off the air emitted by the first air knife. The air knife suction apparatus is arranged upstream of the first air knife in the drying unit longitudinal direction, i.e., the first air knife is arranged between the air knife suction apparatus and the radiator device. This prevents the detached laminar boundary layer from penetrating the region of the respective radiator device. The radiator performance can thus be advantageously increased.

Particularly preferably, each of the drying units comprises a second air knife, which is arranged upstream of the first air knife (30), in particular upstream of the air knife suction apparatus, in the drying unit longitudinal direction (L). The first and second air knife form a so-called double air knife 24.

In addition, the second air knife is preferably configured such that the air jet generated by said second air knife is inclined against the drying unit longitudinal direction of the respective drying unit. In a manner analogous to the first air knife, the relative velocity of the air jet emitted by the second air knife and of the material web conveyed in or substantially in the drying unit longitudinal direction is increased.

Preferably, the air of the first and/or second air knife is tempered, in particular preheated. Tempered air is therefore conveyed onto the material web using the first and/or second air knife. In this way, more water vapor or solvent in the air can be absorbed. The air jet emitted by the first and/or second air knife continues to serve for convective drying of the material web.

In such case, the air knife suction apparatus is used in particular to suction off the supply air of the first air knife. The supply air of the second air knife, i.e., the air emitted by the second air knife, is expediently suctioned off by the intermediate suction apparatus.

According to a particularly preferred embodiment of the apparatus, the conveying region in which the material web is conveyed is enclosed to form a channel (conveying channel, drying channel) which runs in particular continuously along the conveying region. In particular, the respective section of the channel is limited by the drying units and/or the intermediate suction apparatus, and/or the drying units or the intermediate suction apparatus are arranged within the channel. The channel further reduces the risk of an undefined outflow of evaporated solvent into the environment of the apparatus.

Preferably, a suction apparatus referred to as dead space suction apparatus is arranged above the channel, i.e., outside the channel. For example, there is expediently one dead space suction apparatus for each of the drying units, wherein the dead space suction apparatus is arranged outside the channel above the respective radiator device so that heat build-up there is avoided.

According to an advantageous embodiment, a third air knife and/or a further suction apparatus is arranged at a (material web) inlet of the channel for the material web and additionally or alternatively at a (material web) outlet of the channel for the material web. The third air knife or the suction apparatus prevents evaporated solvent from escaping from the apparatus.

The first, second and/or third air knife is suitably oriented such that the entire material web is exposed to the respective air jet. In other words, the impact region of the air jet on the material web is linear and extends transversely to the material web or transversely to the respective drying unit longitudinal direction.

According to a preferred embodiment, each of the drying units has a counter baffle, wherein the conveying region is arranged between the radiator device and the counter baffle. In other words, in each of the drying units the counter baffle is arranged above the conveying region. Preferably, the counter baffle comprises a counter baffle suction apparatus so that solvent evaporating from the material web on the side facing away from the radiator device can be suctioned off.

Preferably, the counter baffle suction apparatus is designed such as to suction off air from the edge region of the material web, i.e., from the end-side region of the material web in a (width) direction transverse to the drying unit longitudinal direction. For this purpose, the counter baffle suction apparatus comprises, for example, two suction openings extending in the drying unit longitudinal direction, which are arranged parallel to one another and spaced apart in a direction transverse to the drying unit longitudinal direction.

According to a suitable embodiment, the side of the counter baffle facing the material web, i.e., the side of the counter baffle facing the radiator device, is designed to reflect infrared radiation. In this way, infrared radiation emitted by the material web or infrared radiation penetrating the material web is reflected back onto the material web. The drying efficiency is thus increased.

Additionally or alternatively, the counter baffle preferably comprises a guide element. They are expediently arranged transversely to the material web, i.e., transversely to the drying unit longitudinal direction. This serves to guide the material web in the conveying region. Consequently, a defined position of the material web in the conveying region with respect to the radiator device is realized. For high durability, the guide element is preferably made of or comprises a ceramic. Alternatively, the guide element is made of steel, for example. To avoid damage to the material web, it expediently has a smooth, i.e., edge-free, cross-section.

According to a preferred embodiment, the radiator suction apparatus of the respective drying unit has a suction direction which encloses an angle of less than 90°, in particular less than 45°, preferably less than 30° with the drying unit longitudinal direction. Preferably, the suction direction is oriented in the drying unit longitudinal direction. In this way, the sucked-in air is directed specifically in the conveying direction of the material web. On the one hand, this prevents the material web from being sucked in towards the radiator device or at least reduces the risk of this happening. As a result, a distance to the material web can be reduced. On the other hand, this allows the air to be sucked in relatively evenly across the entire width of the material web.

According to an advantageous embodiment, air which is suctioned off by the counter baffle suction apparatus and/or by the dead space suction apparatus can be supplied to each of the drying units'first and/or second air knife. Therefore, an air supply of the first and/or the second air knife is and/or can be connected in terms of flow to the counter baffle suction apparatus and/or to the dead space suction apparatus. Since such air is comparatively warm, further heating of the air for the respective air knife is not necessary or is necessary only to a reduced extent. In addition, warm air can absorb the solvent better. Furthermore, cooling of the material web due to the air flowing out from the first or second air knife is avoided.

According to an advantageous embodiment, for energy recovery, in each of the drying units the air suctioned off by its radiator suction apparatus can be fed to a heat exchanger, which is expediently designed as a tube-to-tube heat exchanger. The radiator suction apparatus is therefore fluidically coupled to the heat exchanger.

In an expedient embodiment, a supply fan for the radiator ventilator and a supply fan for the first and/or the second air knife are designed separately from one another, i.e., structurally separate from one another. Additionally or alternatively, the supply fan for the radiator ventilator and the supply fan for the first and/or the second air knife can be adjusted, in particular controlled, independently of one another. In this way, the temperature, volume flow and/or flow velocity of the air flow of the radiator ventilator can be adjusted independently of the jet properties of the first and/or second air knife.

According to an expedient embodiment, a suction rate, i.e., a volume flow for air from the conveying region, of the radiator suction apparatus is set, adjustable, regulated, and/or controllable to be greater than the supply air rate, i.e., the volume flow for air into the conveying region, of the radiator ventilator. In particular, the suction rate is between 1.1 and 1.5 times the supply air rate. The solvents are thus specifically removed from the region of the respective radiator device.

In an advantageous embodiment, the infrared radiators in each drying unit are arranged next to one another in a direction transverse to the drying unit longitudinal direction or transverse to the material web. By deactivating the outer infrared radiators in this direction and/or by reducing the intensity of the infrared radiation emitted by them, the radiation performance can be adapted to material webs with different (material web) widths.

In the following, an exemplary embodiment of the invention is explained in more detail with reference to a drawing. In the figures:

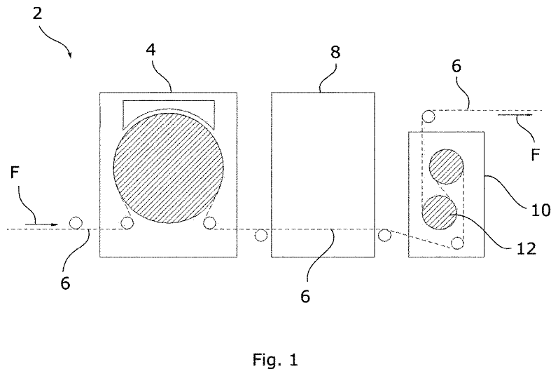

FIG. 1 schematically shows a device for producing a printed material web with a printer for applying printing ink to a material web, with an apparatus for drying the material web and with a cooling device for the material web;

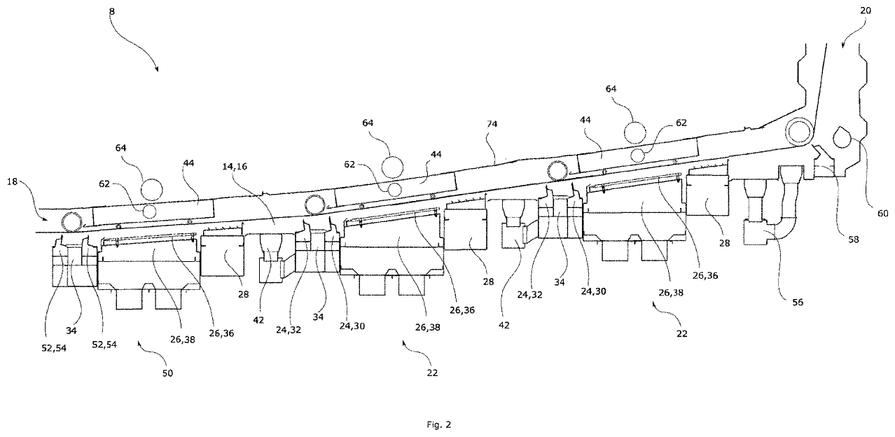

FIG. 2 schematically shows the apparatus for drying the material web in a side view, wherein the apparatus has at least two drying units along the material web, each with a radiator device;

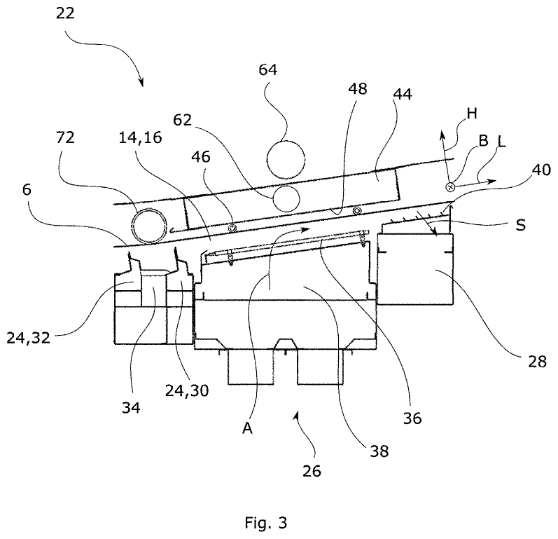

FIG. 3 schematically shows, on an enlarged scale, one of the drying units; and

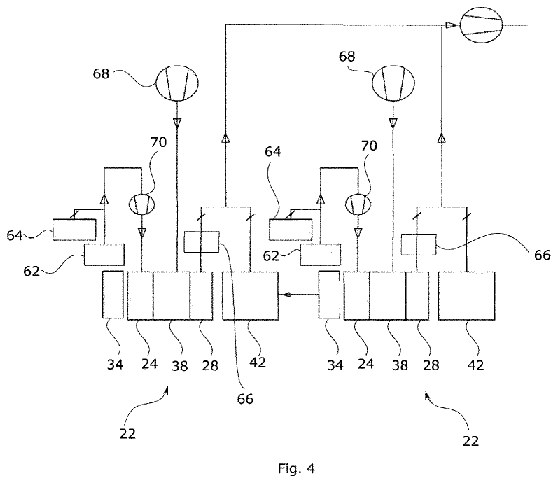

FIG. 4 schematically shows a ventilation diagram for two of the drying units of the apparatus.

Corresponding parts and sizes are always provided with the same reference signs in all figures.

FIG. 1 schematically shows a device 2 for producing a printed material web. The material web comprises a printing apparatus 4, which is designed herein, for example, as a rotary printing press, in particular as a flexographic printing press. Alternatively, the printing apparatus 4 is designed as an inkjet printer. At most, printing ink is applied to a material web 6 guided in the device 2 using the printing apparatus 4, which material web 6 is shown in dashed lines in FIG. 1. The material web 6 is, for example, a paper web, a cardboard web, a carton web, or a film web.

As regards the conveying direction F of the material web, which is represented in FIG. 1 by an arrow, an apparatus 8 for drying the printed material web 6 is arranged downstream of the printing apparatus 4. To dry the material web 6, the latter is conveyed in particular by said apparatus 8. Said apparatus 8 is also referred to below in short as drying apparatus 8. It serves in particular to dry the printing ink applied to the material web 6. For this purpose, the printed material web 6 is irradiated with infrared radiation using the drying apparatus 8. The apparatus 8 is shown in comparative detail in FIGS. 2 and 3 (see also below).

As regards the conveying direction F of the material web downstream of the drying apparatus 8, a cooling apparatus 10 with a number of cooling rollers 12 is arranged. Thus, the printed and dried material web 8 is fed to the cooling device 10 after passing through the drying apparatus 8, so that the material web 6 heated due to the infrared radiation is cooled.

In FIG. 2, the drying apparatus 8 is schematically shown in a side view in comparative detail. The drying apparatus has a channel referred to as conveying channel 14. It encompasses, i.e., limits, the conveying region 16 for the material web 6. The material web 6 is conveyed within the conveying region 16 from a (channel) inlet 18 of the conveying channel 14 to a (channel) outlet 20 of the conveying channel 14. During this process, the material web is deflected in the conveying channel 14 by means of guide rollers 72.

The drying apparatus 8 comprises drying units 22, namely two drying units 22 according to the exemplary embodiment shown herein. Each of these drying units 22 comprises a double air knife 24, a radiator device 26 and a radiator suction apparatus 28, which are arranged one behind the other in a (drying unit) longitudinal direction L of the respective drying unit 22. The drying unit longitudinal direction L corresponds to the main extension direction of the conveying channel 14 in the region of the respective drying unit 22.

The respective double air knife 24 comprises a first air knife 30 and a second air knife 32, wherein an air knife suction apparatus 34 for the supply air of the first air knife 30 and the aerosols entrained therein, in particular solvents or water vapor, is arranged between the first and the second air knife 30, 32. The second air knife 32 is arranged upstream of the air knife suction apparatus 34 in the drying unit longitudinal direction L. The two air knives 30, 32 are arranged such that the air jets emitted by them are inclined against the drying unit longitudinal direction L. Starting from the nozzle of the respective air knife 30 or 32, the air jet is thus oriented towards the channel inlet 18.

Preferably, the air jet generated by the first and second air knife 30, 32 extends over the entire width of the material web 6 and/or of the conveying channel 14. The air jet thus preferably extends over the entire width of the material web 6 in a direction perpendicular to the plane of drawing.

By means of the first and second air knives 30 and 32, a laminar boundary layer carried along the material web 6 is detached, so that reflection of the infrared radiation at this boundary layer in the region of the radiator device 26 following in the drying unit longitudinal direction L is avoided.

The radiator device 26 of each of the drying units 22 comprises a number of infrared radiators 36 which are configured to emit infrared radiation for drying the printing ink. If the respective radiator device 26 has more than one infrared radiator 36, they are arranged next to one another in a direction transverse to the drying unit longitudinal direction L, i.e., a (width) direction B along the width of the material web 6.

Each of the radiator devices 26 further comprises a radiator ventilator 38, which supplies air A to the infrared radiators 36 of the respective radiator devices 26 in order to control their temperature, in particular to cool them. The radiator ventilator 38 is configured such that the generated air flow is directed towards the material web 6, i.e., into the conveying region. In summary, the radiator ventilator 38 is configured to emit air A in such a way that it first reaches the infrared radiators 36 and then the material web 6. The radiator suction apparatus 28 has a suction direction S which encloses an angle of less than 90°, approximately 45° according to the exemplary embodiment shown herein, with the drying unit longitudinal direction L. Preferably, the air emitted by the radiator ventilator 38 is sucked in in the drying unit longitudinal direction L. For this purpose, the respective radiator suction apparatus 28 comprises, for example, an air guide element 40. In summary, the air A supplied from the radiator ventilator 38 into the conveying region 16 and the aerosols entrained therein, in particular water vapor and/or solvents of the printing ink, are suctioned off by means of the radiator suction apparatus 28.

In summary, the two drying units 22 comprise the double air knife 24, wherein the radiator device 26 is arranged downstream of the double air knife 24 in the drying unit longitudinal direction L, and the radiator suction apparatus 28 is arranged downstream of the radiator device 26 in the drying unit longitudinal direction L.

An intermediate suction apparatus 42 is arranged between the drying units 22 in each case. It is provided to suction off solvent or water evaporated from the material web 6 in the region between the drying units 22 and, if applicable, the supply air of the second air knife 32 of the drying unit 22 following in the conveying direction F of the material web 6.

The drying units 22 and the intermediate suction apparatuses 42 are arranged under the conveying region and limit it counter to the channel vertical direction H, i.e., counter to a direction perpendicular to the drying unit longitudinal direction L and to the width direction B. In other words, the intermediate suction apparatuses 42 and the drying units 22 form a channel boundary. On the opposite side, the channel is limited by a channel wall 74.

To avoid heat build-up in the region above the conveying channel 14, a dead space suction apparatus 64 is arranged there, i.e., outside the conveying channel 14.

Each of the drying units 22 comprises a counter baffle 44 which limits the conveying region in the channel vertical direction H. The material web 6 is conveyed in the conveying region between the counter baffle 44 and the radiator device 26 (radiator unit). In other words, in each of the drying units 22, the conveying region 16 is arranged between the infrared radiators 36 and the counter baffle 44.

The side 48 of the respective counter baffle 44 facing the conveying region 16, i.e., the side facing the material web 6, is designed to reflect infrared radiation, in particular the infrared radiation emitted by the infrared radiators 36. The respective counter baffle 44 further comprises guide elements 46 for guiding the material web 6, which are arranged on the side 48 facing the material web 6. Said guide elements 46 are preferably formed from a ceramic and/or have a smooth, i.e., edge-free, cross section in a sectional plane perpendicular to the width direction B.

Each of the counter baffles has a counter baffle suction apparatus 62, by means of which counter baffle suction apparatus water and/or solvent, which evaporates from the material web 6 on the side facing away from the respective radiator device 26, can be suctioned off.

According to the exemplary embodiment shown herein, the drying apparatus 8 comprises a further drying unit 50 with a radiator device 26 and a radiator suction apparatus 28 on the channel inlet side. The further drying unit 22 comprises a further double air knife 52 with two third air knives 54, which, in comparison to the first and second air knives 30, 32 of the other drying units 22, are designed such that the air jets emanating therefrom are inclined perpendicular to the drying unit longitudinal direction L or even in the drying unit longitudinal direction L. Therefore, an undesired escape of evaporated water and/or solvent through the channel inlet 18 into an environment of the drying apparatus 8 is avoided.

Furthermore, an end suction apparatus 56, a further air knife 58 and a recirculating air suction apparatus 60 are arranged on the channel outlet side to prevent evaporated water or solvent from escaping through the channel outlet 20 into the environment of the drying apparatus 8.

FIG. 4 schematically shows a ventilation diagram for the two drying units 22. Accordingly, for each of the drying units 22, the air sucked in by the dead space suction apparatus 64 and the counter baffle suction apparatus 62, which contains comparatively little or no solvent or water vapor, can be fed to the double air knife 24, i.e., the first air knife 30 and the second air knife 32, to generate the respective air jet. In other words, the first air knife 30 and the second air knife are connected on the air supply side to the counter baffle suction apparatus 62 and the dead space suction apparatus 64.

The air A suctioned off by the radiator suction apparatus 28 is first fed to a heat exchanger 66, which is expediently designed as a tube-to-tube heat exchanger. The radiator suction apparatus 28 is therefore coupled to the heat exchanger 66 on the outlet side.

Furthermore, a supply fan 68 for the radiator ventilator 38 is formed in the respective drying unit 22, separate from a supply fan 70 for the double air knife 24. The two supply fans 68, 70 can be adjusted independently of one another. Thus, the supply air for the double air knife 24 can be adjusted independently of the supply air of the radiator ventilator 38. In particular, the volume flow, the air temperature and/or the flow velocity of the supply air for the double air knife 24 can be adjusted independently of the volume flow, the air temperature and/or the flow velocity of the supply air for the radiator ventilator 38, and vice versa.

For targeted suctioning of aerosols in the region of the infrared radiators 36, the suction rate of the radiator suction apparatus 28, i.e., the volume of air suctioned off by the radiator suction apparatus 28 per unit of time, is preferably between 1.1 times and 1.5 times the supply air rate of the radiator ventilator 38, i.e., the volume of air supplied by the radiator ventilator 38 per unit of time.

The invention is not limited to the exemplary embodiments described above. Rather, within the scope of the claims, other variants of the invention can also be derived from this by a person skilled in the art without departing from the subject matter of the invention. In particular, all individual features described in connection with the exemplary embodiments and/or in the claims can also be combined with one another in other ways without departing from the subject matter of the invention.

### LIST OF REFERENCE SIGNS

2 Device for producing a printed material web
4 Printing apparatus
6 Material web
8 Apparatus
10 Cooling apparatus
12 Cooling rollers
14 (Conveying) channel
16 Conveying region
18 Inlet
20 Outlet
22 Drying unit
24 Double air knife
26 Radiator device
28 Radiator suction apparatus
30 First air knife
32 Second air knife
34 Air knife suction apparatus
36 Infrared radiator
38 Radiator ventilator
40 Air guide element
42 Intermediate suction apparatus
44 Counter baffle
46 Guide element
48 Side of the counter baffle
50 Further drying unit
52 Further double air knife
54 Third air knife
56 Suction apparatus
58 Further air knife
60 Recirculating air suction apparatus
62 Counter baffle suction apparatus
64 Dead space suction apparatus
66 Heat exchanger
68 Supply fan for the radiator ventilator
70 Supply fan for the first air knife and for the second air knife
72 Guide roller
74 Channel wall
A Air
B Width direction
F Conveying direction
H Vertical direction
L Drying unit longitudinal direction
S Suction direction

1. An apparatus for drying a printed material web, the apparatus comprising:
at least two drying units,
wherein each of the drying units has a radiator device arranged under a conveying region for the material web,
wherein the radiator device has a number of infrared radiators and has a radiator ventilator for supplying air to the infrared radiators and into the conveying region;
a radiator suction apparatus arranged downstream of the radiator device in the drying unit longitudinal direction for the air supplied by the radiator ventilator into the conveying region;
a first air knife arranged upstream of the radiator device in the drying unit longitudinal direction for generating an air jet for detaching a laminar boundary layer on the material web; and
wherein an intermediate suction apparatus arranged between the drying units for suctioning off evaporated solvent and/or water vapor.

2. The apparatus according to claim 1, wherein the first air knife of the respective drying unit is configured to generate an air jet which is inclined against the drying unit longitudinal direction.

3. The apparatus according to claim 1, wherein each of the drying units has an air knife suction apparatus for suctioning off the air emitted by the first air knife wherein the air knife suction apparatus is arranged upstream of the first air knife in the drying unit longitudinal direction.

4. The apparatus according to claim 1, wherein each of the drying units has a second air knife arranged upstream of the first air knife and/or upstream of the air knife suction apparatus in the drying unit longitudinal direction and/or wherein the second air knife is configured such that the generated air jet is inclined against the drying unit longitudinal direction.

5. The apparatus according to claim 4, wherein the conveying region for the material web is enclosed to form a conveying channel and/or in that a dead space suction apparatus is arranged above the conveying channel to avoid heat build-up.

6. The apparatus according to claim 5, wherein a third air knife and/or a suction apparatus is arranged at an inlet and/or at an outlet of the conveying channel for the material web to prevent the escape of evaporated solvent from the conveying channel.

7. The apparatus according to claim 6, wherein each of the drying units has a counter baffle wherein the conveying region is arranged between the infrared radiators and the counter baffle.

8. The apparatus according to claim 7, wherein the side of the counter baffle facing the conveying region is designed to reflect infrared radiation.

9. The apparatus according to claim 7, wherein the counter baffle has a guide element for guiding the material web in the conveying region.

10. The apparatus according to claim 1, wherein the radiator suction apparatus of the respective drying unit has a suction direction which encloses an angle of less than 90° with the drying unit longitudinal direction.

11. The apparatus according to claim 7, wherein the air suctioned off by the counter baffle and/or by the dead space suction apparatus is fed to the first air knife and/or the second air knife.

12. The apparatus according to claim 1, wherein the air suctioned off by the radiator suction apparatus is fed to a heat exchanger.

13. The apparatus according to claim 4, wherein a supply fan for the radiator ventilator and a supply fan for the first air knife and/or for the second air knife are separate from one another and/or can be adjusted independently of one another.

14. The apparatus according to claim 1, wherein a suction rate of the radiator suction apparatus is adjustable and/or adjusted to be greater, than the supply air rate of the radiator ventilator.

15. The apparatus according to claim 1, wherein the infrared radiators of the respective radiator device are arranged next to one another in a direction transverse to the drying unit longitudinal direction.
